(19) United States
(12) Patent Application Publication
(10) Pub. No.: US 2004/0136589 A1
(43) Pub. Date: Jul. 15, 2004

(54) Method and apparatus for modifying two-dimensional images

(76) Inventor: Norman King Breslow, North Hills, CA (US)

Correspondence Address: BRIAN M BERLINER, ESQ, O'MELVENY & MYERS, LLP, 400 SOUTH HOPE STREET, LOS ANGELES, CA, 90071-2899, US

(21) Appl. No.: 10/342,721

(22) Filed: Jan. 15, 2003

(51) Int. Cl. G06K 9/00

(52) U.S. Cl. 382/154

(57) ABSTRACT

A method of modifying two-dimensional images includes providing a two-dimensional image that has a plurality of image columns. A first set of columns is interlaced with a second set of columns to prepare an interlaced image, and the first set of columns comprises the plurality of image columns of the two-dimensional image. The second set of columns comprises columns that are horizontally offset from the first set of columns and that are derived from the two-dimensional image. In a first embodiment, the plurality of image columns are horizontally offset to provide an offset image that comprises the second set of columns, which are horizontally offset. In a second embodiment, the two-dimensional image having a plurality of columns is interlaced with itself, and the second set of columns is derived directly from the two-dimensional image. In a third embodiment, an electronic system includes an input device configured to receive an image and a processing unit in electrical communication with the input device. The processing unit is configured to divide the image into a plurality of image columns and to interlace a first and second set of columns to provide an interlaced image. The first set of columns comprises substantially all of the plurality of image columns, and the second set of columns comprises columns horizontally offset from the first set of columns. The second set of columns are derived from the image.

### BACKGROUND OF THE INVENTION

1. Field of the Invention

The present invention relates to creating a modified image from a two-dimensional image, and specifically, to creating a three-dimensional image from a two-dimensional image.

2. Description of Related Art

For quite some time, people have been fascinated with modified images that appear to have illusionary effects, and particularly with three-dimensional (3D) images. A large market for modified and 3D images, both still and moving, has been created as a result. Many attempts of forming 3D images and films have been made to meet these market demands. Most of these efforts attempt to mimic the way that the brain achieves a sense of depth perception. Briefly, the brain achieves depth perception by perceiving an object from two views seen from different angles. The two views are left and right eye views that are horizontally displaced from one another. Based on this concept, efforts have been made to create 3D images by using two different views of the same object.

In one method, two views of a scene are printed with two colors, usually red for the left eye and blue for the right eye. A viewer then uses a red filter for the right eye and a blue filter for the left eye to view the image. This method is both time consuming and costly because it requires taking two views of a scene and because the views must be printed in different colors. This method also undesirably requires the viewer to use red and blue filters to view the image.

In another method, stereoscopic cameras are used to take pictures of an object. The stereoscopic cameras have two lenses that capture two separate images of the object. Each image is taken from one of the lenses and captures the object from a different vantage point. Specially formatted viewer glasses are used to view the two images to perceive a 3D image. This method is cost prohibitive because there are relatively few stereoscopic cameras in production today, and the stereoscopic cameras that are in production are expensive. Other stereoscopic cameras that were manufactured fifty years ago are also available, but such stereoscopic cameras are antiquated by today's standards and are often not in good working order. Moreover, using stereoscopic cameras to create 3D images is inconvenient because viewer glasses are required to view the images.

Other modifications of stereoscopic cameras include positioning a standard single lens camera on a sliding stand, and taking a picture of a stationary object in one position. The camera is then slid on the stand, and a picture of the same object is taken at a new position that is horizontally displaced from the original position. The two pictures can then be viewed through specially formatted viewer glasses to perceive the object in three dimensions. This method is very cumbersome and time consuming because it requires a sliding stand that must be properly positioned to take pictures. Further, human error, in either sliding the camera or positioning the stand, often results in stand movement. The stand movement, in turn, may cause the object to appear undesirably distorted when viewed through the viewer glasses.

Still another modification includes scanning a 3D object into a computer, moving the 3D object on the scanner, and rescanning the 3D object in the new position. The two images of the 3D object are then interlaced using known software applications. A lenticular sheet is placed atop the interlaced image to create a 3D image of the object. A lenticular sheet comprises a plurality of lenticules positioned next to one another. A lenticule is a long semi-cylindrically shaped lens. The curvature of the lenticules creates illusionary effects when images placed underneath the lenticules are viewed. This method, however, is limited by the parameters of the scanner. Most scanners are flat and relatively small, thus limiting the objects that can be scanned to relatively small objects that have a low height. Moreover, human error in sliding the object may also result in undesired distortion in the interlaced image.

In yet another modification, a copy of a two-dimensional image is made to provide left and right images, and corresponding objects within the images are selected. The selected objects are displaced on the images to the left or to the right depending on whether the selected objects should appear closer or farther from the viewing plane. Selected objects in the left image are displaced in one direction, and selected objects in the right image are displaced in the opposite direction. The distance that the objects are displaced depends on how close or far the objects should appear. The right and left images having the displaced objects can be viewed together with polarizing glasses and other 3D display devices. This method is undesirably complex because objects must be selected and displaced different amounts.

As a result, there still remains a need for an efficient method to make a modified image, particularly a 3D image, that is not limited by the shortcomings of the aforementioned known methods.

### SUMMARY OF THE INVENTION

The present invention addresses the need for an efficient method to make a modified image that is not limited by the shortcomings of the aforementioned methods by using only one two-dimensional (2D) image to create a modified image, and in particular, a three-dimensional (3D) image.

In a first embodiment of the invention, a 2D image is provided so that it has a plurality of image columns. A copy of the 2D image having a plurality of columns is made, and substantially all of the plurality of columns of the copy are offset to provide an offset image having horizontally offset columns. In a preferred embodiment, all of the plurality of columns are offset an equal amount. The plurality of columns of the 2D image and the horizontally offset columns of the offset image are interlaced to provide an interlaced image, and a lenticular sheet is positioned atop the interlaced image to provide a modified image. As a result, a modified image is provided from one two-dimensional image, without moving a camera in another position or moving an object. Further, the modified image is provided without the need to select objects within the image and without the need to offset the objects different amounts, which known methods undesirably require.

In an alternate embodiment, the number of columns that the 2D image is comprised of is based in part on a desired width of the interlaced image. In another embodiment, the amount that the 2D image is horizontally offset is based in part on the total number of columns that the 2D image is comprised of. In yet another embodiment, an output device, such as a printer having a predetermined resolution, is used to produce the interlaced image on a sheet of paper, and a lenticular sheet having a predetermined lenticule density is positioned atop the interlaced image. During the interlacing step, a predetermined number of copies of columns of the 2D image and the offset image are made. The number of copies made is based in part on the predetermined resolution of the output device and the predetermined lenticule density of the lenticular sheet.

In a second embodiment, a digitized image is interlaced with itself to provide the interlaced image. A two-dimensional image is provided having a plurality of image columns. A first set of columns is interlaced with a second set of columns to provide an interlaced image, and the first set of columns comprises substantially all of the plurality of image columns. The second set of columns comprises columns that are horizontally offset from the first set of columns and that are derived directly from the 2D image. A lenticular sheet is placed atop the interlaced image to provide a modified image.

Another embodiment of the invention comprises a modified image that includes a first and second plurality of pixel columns formed on a form of media, such as a sheet of paper. The second plurality of pixel columns are derived from the first plurality of pixel columns and are horizontally offset with respect to the first plurality of pixel columns. The first and second plurality of pixel columns are interlaced, and a lenticular sheet is positioned atop the interlaced columns so that each lenticule of the lenticular sheet overlays a predetermined number of interlaced columns. In another embodiment, the predetermined number of interlaced columns that each lenticule overlays is based in part on the number of lenticules in the lenticular sheet and on the number of columns comprising the first plurality of pixel columns.

In a third embodiment, an electronic system includes an input device and a processing unit. The input device is configured to receive an image, and the processing unit is in electrical communication with the input device. The processing unit is configured to divide the image into a plurality of image columns and to interlace a first and second set of columns to provide an interlaced image. The first set of columns comprises substantially all of the plurality of image columns, and the second set of columns comprises columns horizontally offset from the first set of columns. The second set of columns is derived from the image. In one embodiment, the electronic system comprises a digital camera, and the input device comprises a camera lens and a light sensor. In yet another embodiment, the electronic system comprises a computer system, and the input device is a scanner.

A more complete understanding of the method and apparatus for making a modified image will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a two-dimensional image;

FIG. 2 is a schematic diagram of an electronic system that is configured to carry out methods of the invention;

FIG. 3 is a horizontally offset image of the two-dimensional image shown in FIG. 1;

FIG. 4 shows a two-dimensional image and a horizontally offset image of a shaded geometric pattern having a plurality of columns, and also shows the two-dimensional image interlaced with the horizontally offset image;

FIG. 5 is the horizontally offset image of FIG. 3 interlaced with the two-dimensional image of FIG. 1;

FIG. 6 shows a two-dimensional image of a geometric pattern having a plurality of columns interlaced with itself;

FIG. 7 is a cross-sectional view of a portion of a lenticular sheet overlaying a sheet of paper having interlaced columns formed thereon; and,

FIG. 8 shows a top view of a lenticular sheet having a plurality of lenticules.

### DETAILED DESCRIPTION OF THE PREFERRED EMBODIMENT

The present invention pertains to creating a modified image from a two-dimensional (2D) image. A 2D image that is divided into a plurality of image columns is provided, and a first set of columns is interlaced with a second set of columns. The first set of columns comprises substantially all of the plurality of image columns, and the second set of columns comprises columns that are horizontally offset from the first set of columns and that are derived from the 2D image. In a first embodiment, in a copy of the 2D image, substantially all of the image columns are horizontally offset to provide an offset image having horizontally offset columns. The plurality of image columns of the 2D image and the horizontally offset columns of the offset image are interlaced with one another to provide an interlaced image, and a lenticular sheet is positioned atop the interlaced image. When a user views the lenticular sheet with the interlaced image positioned underneath the lens, the original 2D image is modified, and, in one embodiment, the modified image appears as a three-dimensional (3D) image.

Known methods of creating a 3D image require expensive equipment, such as stereoscopic cameras having two lenses, and also require two separate images. Moreover, to view 3D images created by the known methods, viewing lenses are required. The present invention alleviates the need for multiple lenses, separate images of an object taken at different angles, and viewing lenses.

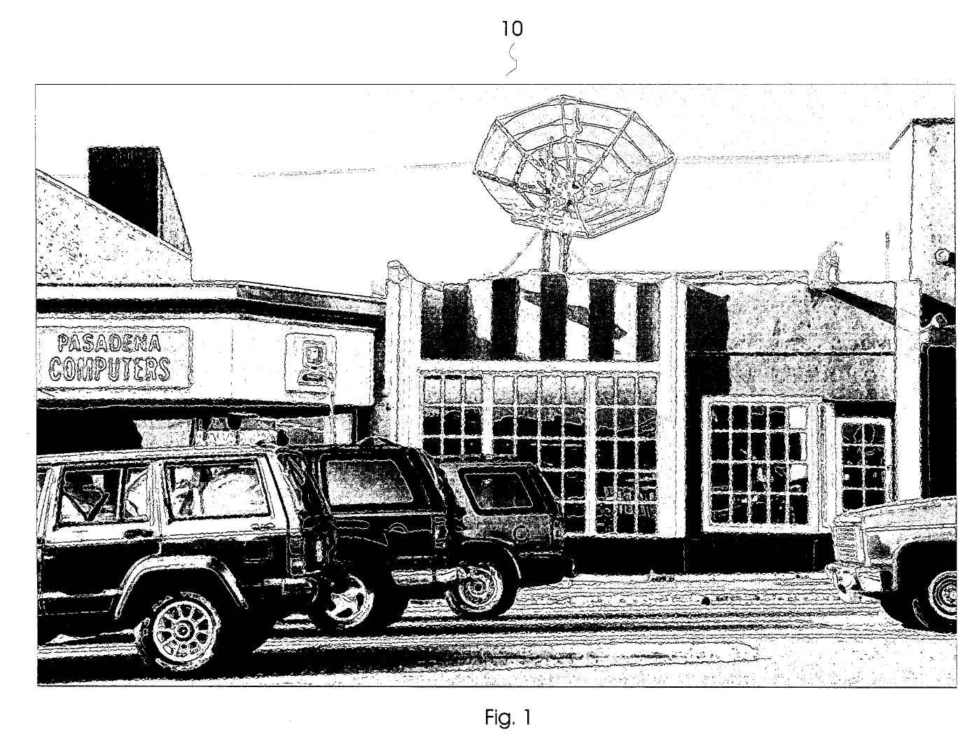

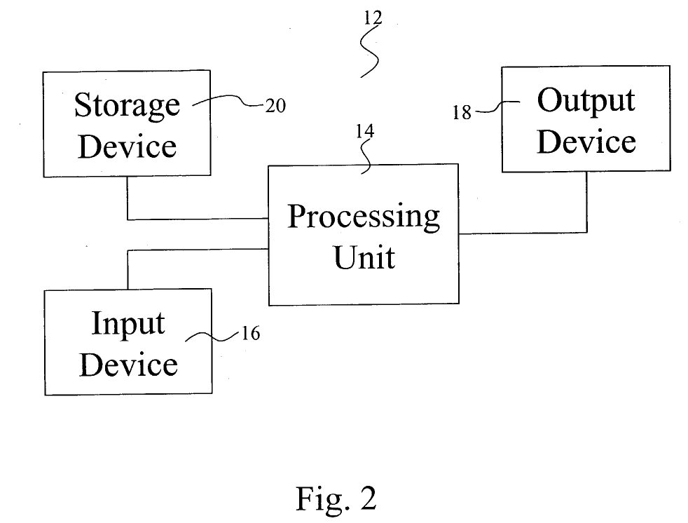

Pursuant to a first embodiment of the invention, a 2D image 10 (FIG. 1) is provided, and the image is divided into a plurality of image columns. In one embodiment, the image is digitized so that the digitized image comprises a plurality of columns and rows of pixels. If the image is digitized, then the plurality of image columns comprises columns of pixels. Note that the term “2D image” is to be construed as any image that is flat, and includes images that are flat but still appear to be in three dimensions or that have other illusionary effects. Examples of a “2D image” include, but are not limited to, photographic prints, slides, negatives, drawings, and paintings. A pixel is a picture element, and the size of the pixel depends on the size at which the image is being viewed. An image that has a fixed number of pixels will have a higher resolution when the image is reduced in size because there will be more pixels per square inch. The image will have a lower resolution when it is enlarged because there will be less pixels per square inch. In one embodiment of the invention, as shown in FIG. 2, an electronic system 12 that includes a processing unit 14 and an input device 16 can be used to divide the image into a plurality of image columns. The electronic system 12 can also include a storage device 20 and an output device 18.

The number of pixels in the inputted image typically depends on the input device. For example, the number of solar cells in a light sensor used in a digital camera or a scanner determines the number of pixels in the inputted image. Other input devices, such as scanners, allow a user to vary the number of pixels of the inputted image by adjusting controls of the input device. Note that in other embodiments, the number of columns of pixels of the inputted image is adjusted based in part on the desired size of the modified image. Thus, the input device and processing unit are configured to provide inputted images having a predetermined number of pixel columns that is based in part on the desired sizes of the modified images. The processing unit can also be used to enlarge or decrease the number of pixels of the inputted image by interpolation and by other methods that those skilled in the art will appreciate.

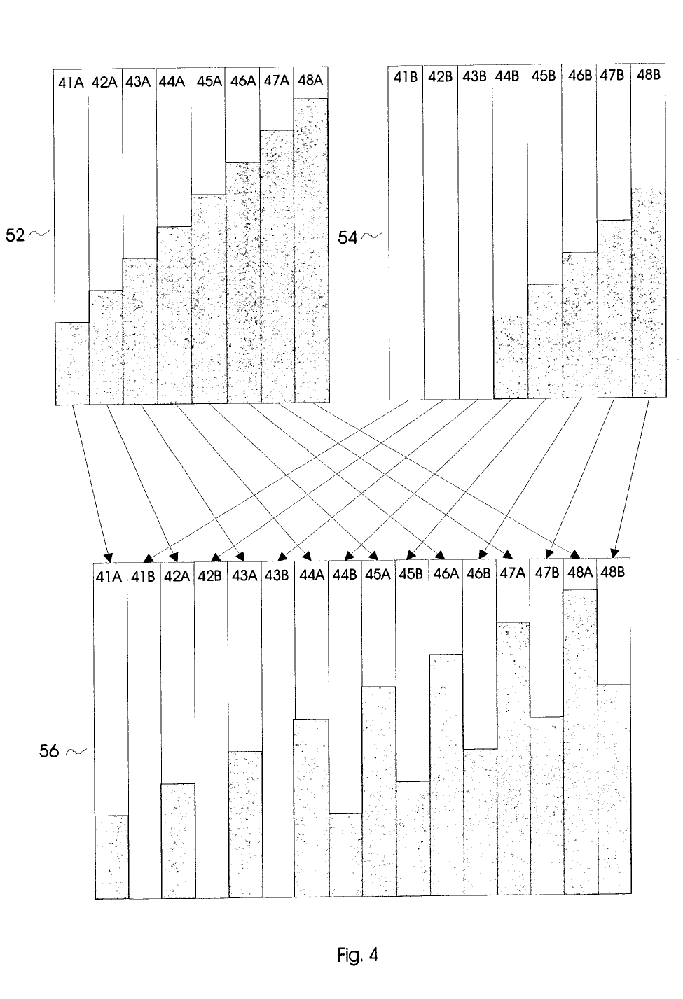

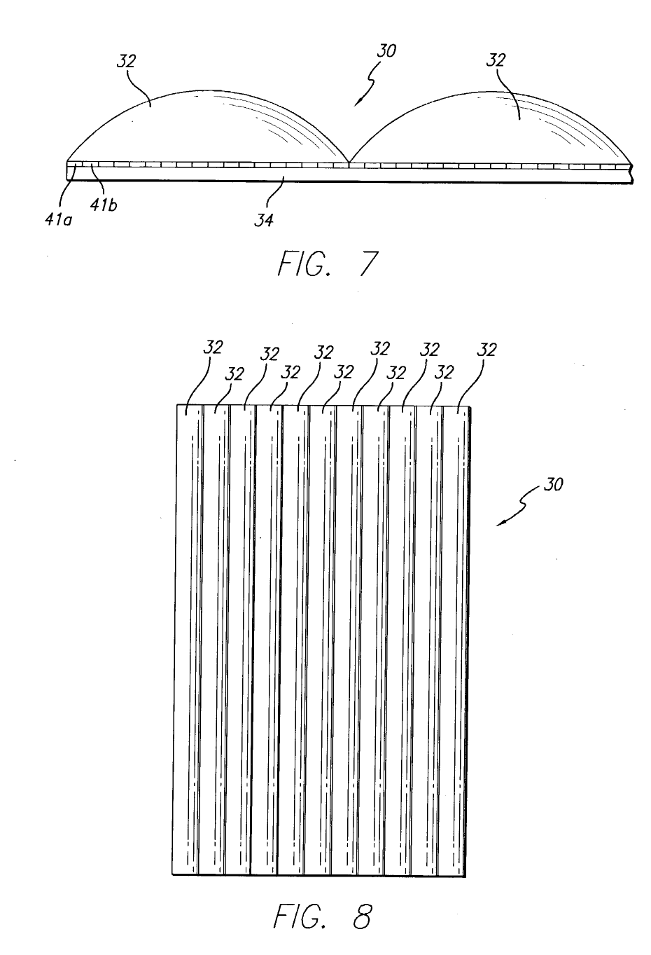

In the first embodiment, the digitized image is copied, and in the copy, substantially all of the plurality of image columns are horizontally offset to create an offset image 54 that comprises a plurality of horizontally offset columns (41B-48B), as shown in FIG. 4. The processing unit 14 (FIG. 2) is used to make a copy of the digitized image, and is used to offset the copy of the digitized image to create the offset image 22. The offset image 22 can be stored in the storage device 20. The number of pixels that the columns are offset depends on user preferences. In general, images that have a greater number of columns of pixels are offset more than images that have fewer columns. Also, in general, the greater the desired 3D effect, the more the images are offset. If an image is horizontally offset beyond a threshold limit (in the number of pixels), features of the image can appear slightly distorted or to be moving when the interlaced image is viewed through a lenticular sheet 30 (FIGS. 7-8). Thus, if a user desires a distorted image or an image that has a feature that appears to be moving, the user may offset the image beyond the threshold limit. The particular threshold limit varies depending on the location of the feature within the image.

In one embodiment, a digitized image that is about 800 pixels wide and about 1200 pixels high is offset by about one to about five pixels. In another embodiment, an image that is about 3000 pixels wide and about 4500 pixels high is offset by about ten to about fifteen pixels. In yet another embodiment, one may offset the image by about one percent of the width of the image. For example, if the image were 5271 pixels wide, it would be offset by about 53 pixels as a starting test point. Those skilled in the art will appreciate that the number of pixels that the image will be offset depends on user preferences, and may be an iterative process. For example, if offsetting an image that is 800 pixels wide by about five pixels does not provide the desired modified image, the image may be offset a different amount in a second iteration to produce the desired effect in the modified image.

In one embodiment, a processing unit 14 of a computer system is used to offset the image. Paint programs may be used in conjunction with the computer system to perform the offset function. For example, the Corel Photo-Paint® programs (Versions 5 and 8), both by Corel® Corporation, or the Adobe Photoshop® program by Adobe® Corporation may be used.

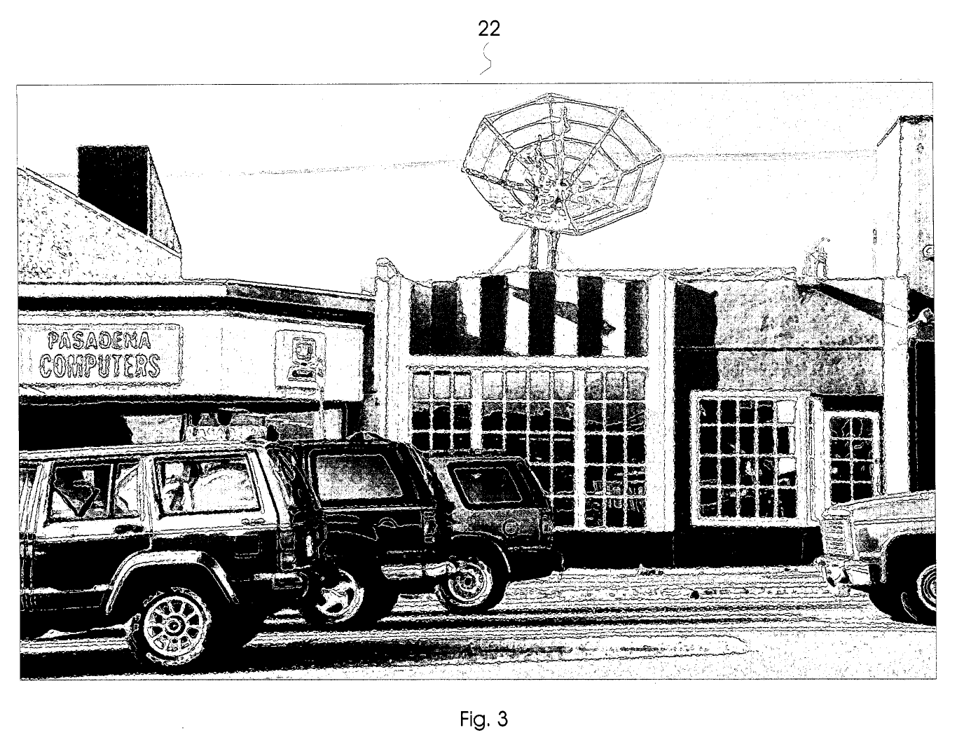

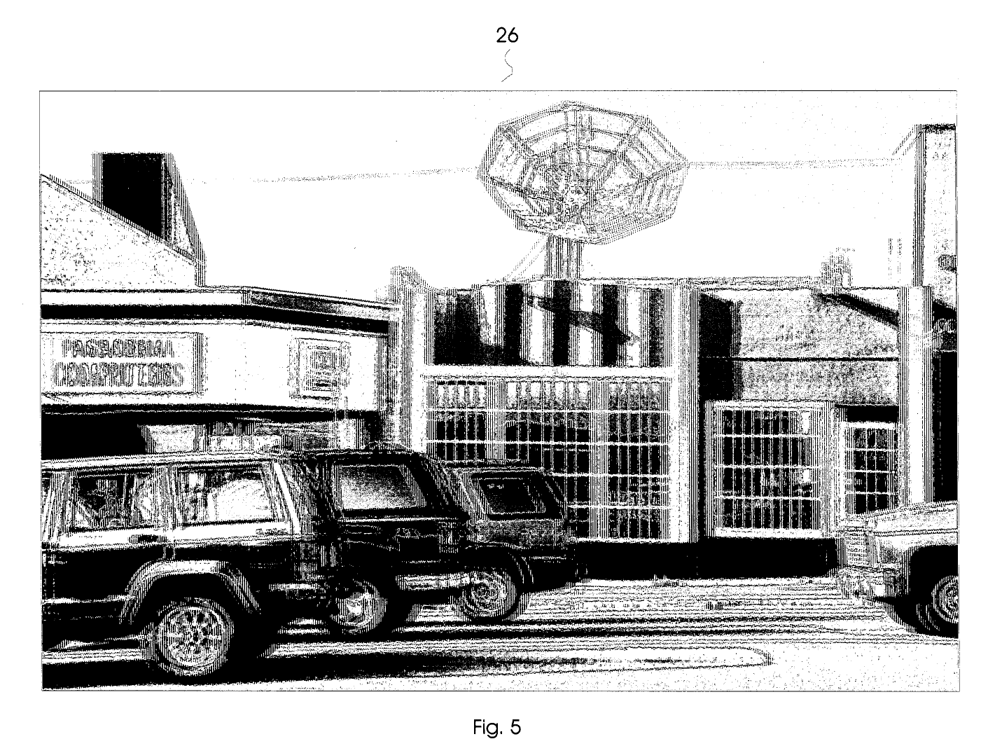

In the first embodiment, a first set of columns comprising substantially all of the plurality of image columns of the digitized image is interlaced with a second set of columns that is comprised of the horizontally offset columns of the offset image. For descriptive purposes, in FIG. 4, a two-dimensional image of a shaded geometric pattern 52 is shown divided into a plurality of image columns (41A to 48A), and an offset image 54 is shown divided into a plurality of horizontally offset columns (41B to 48B). To interlace the digitized and the offset images, a column of the digitized image (column 41A) is positioned adjacent to a corresponding horizontally offset column (column 41B). The remaining columns are interlaced in the same manner to produce the interlaced image 56. A column diagram of the interlaced image 56 is shown in FIG. 4, and an exemplary interlaced image 26 of the 2D image 10 (FIG. 1) interlaced with the offset image 22 (FIG. 3) is shown in FIG. 5. The processing unit 14 can create the interlaced image and store the interlaced image in the storage device 20 (FIG. 2). An output device 18, such as a printer, can then print the image onto media, such as paper 34. The output device 18 can also be a commercial printer and directly print the interlaced image onto a lenticular sheet 30 (FIG. 8).

Note that, as shown in FIG. 4, if the entire digitized image is offset, portions of the digitized image will be cropped in the offset image. For example, the digitized image was offset three columns to the right, and in the offset image, three columns of the digitized image (columns 46A to 48A) were cropped. The cropping effect is typically nominal, and depending on the preferences of the user, the effect may be preserved or removed. To remove the cropping effect, the digitized image can be modified so that there is a white border around the image of interest. Modification may be accomplished by, for example, increasing the width of the digitized image so that there are additional columns to the left or right of the image that will be cropped. In the digitized image 52, for example, there would be an additional three blank columns of pixels to the right of column 48B so that the three blank columns would be cropped, not the image. Note that there may be an artifiact in the interlaced image 56, as shown by columns 41a, 41b, 42a, 42b, 43a, and 43b of FIG. 4. An artifact in the interlaced image is image columns of the digitized image that are interlaced with horizontally offset columns of the offset image that are blank because of the offset. Typically, the width of the artifact is nominal, and depending on the preferences of the user, the artifact may be cropped or preserved.

In one embodiment, as shown in FIG. 7, a lenticular sheet 30 is positioned atop a form of media, such as a sheet of paper 34, having the interlaced image formed thereon so that each lenticule is positioned over a predetermined number of columns of the interlaced image. As shown in FIG. 8, a lenticular sheet 30 is comprised of a plurality of lenticules 32 positioned next to one another, and a lenticule is a long lens that has a semi-circular cross section. The curvature of the lenticules 32 causes an image positioned below the lenticular sheet to have illusionary effects when viewed, and the interlaced image appears as a modified image having illusionary effects when the lenticular sheet is positioned atop the interlaced image. In one embodiment, the number of columns of the interlaced image that are underneath one lenticule depends in part on the resolution of the output device, such as the dots per inch (DPI) printing ability of a printer, and the lenticule density (number of lenticules per inch (LPI)) of the lenticular sheet. The number of columns is equal to the DPI of the printer divided by the LPI of the lenticular sheet. In one embodiment, the DPI is 720 and the LPI is 40, and there are about eighteen columns of pixels underneath each lenticule. The interlaced columns are then repeated underneath the lenticules a predetermined number of times, depending on the number of interlaced images. Specifically, the total number of columns underneath one lenticule (eighteen in the example above) is divided by the number of interlaced images. Thus, if there were two interlaced images, one digitized image and one offset image, each column of pixels of the digitized and offset images would be repeated nine times under each lenticule. Accordingly, if, for example, there were three images, the columns would be repeated six times. In the exemplary diagram shown in FIG. 4, columns 41a and 41b would each be repeated nine times, and when printed out, one lenticule would be positioned atop of the eighteen columns that comprise columns 41a and 41b repeated nine times, as shown in FIG. 7. Those skilled in the art will appreciate that, in other embodiments, instead of repeating the columns nine times, the columns may be interpolated.

The size of the desired interlaced image also affects the width, in pixels, of the digitized image and the offset image. For example, if the desired interlaced image is to be about 8.5 inches wide and the printer has a resolution of 720 DPI, the desired interlaced image should have a width of about 6120 columns of pixels (720 DPI * 8.5 inches). If, as in the embodiment described above, there are about eighteen columns underneath each lenticule 32, the interlaced image will be about eighteen times wider than the digitized and offset images. Thus, each digitized and offset image should be about 340 columns of pixels, or, in other words, be about 340 pixels wide (6120 pixels/18 images). Note that determining the width in pixels of the digitized image is an iterative process because of tolerances in the actual LPI and DPI of lenticular sheets 30 and output devices, respectively, versus the stated LPI and DPI. Further, depending on the preferences of the user, the width of the digitized image can be increased or decreased. In one embodiment, a digitized image having a width of about 590 pixels produced a desired modified image having a width of about 8.5 inches when used with a lenticular sheet 30 having a 40 LPI density and a printer having a 720 DPI resolution. Note that when determining the desired width of the digitized image, one may also use interpolation and other known methods to either shrink or stretch the width of the digitized image.

As those skilled in the art will appreciate, there are several different ways to interlace images, and the embodiment provided above is merely an example of one way to interlace images. Any of the known interlacing methods may be used to interlace the first and second sets of columns. In one embodiment, a processing unit 14 of a computer system is used to interlace the images, and an interlacing software application is used in conjunction with the processing unit 14 to perform the interlacing function. For example, the Magic Interlacer Pro 100 available from ProMagic™ can be used. There are several other software applications that can be used in conjunction with a computer system to interlace images. Further, the number of interlaced images can vary. In one embodiment, only two images, the offset image and the digitized image, are interlaced. But, in other embodiments, there may be more than two interlaced images. For example, the digitized image, a first offset image that has been offset by about five columns, and a second offset image that has been offset by about ten columns, can be interlaced.

Depending on the preferences of the user, the interlaced image may be vertically stretched or shrunk, and the processing unit 14 is typically used to stretch or shrink the image. In one embodiment, the interlaced image is stretched to rectify any distortion caused by increasing the width of the interlaced image with respect to the width of the digitized image. For example, if the interlaced image is eighteen times wider than the digitized image, the height of the interlaced image is stretched to eighteen times the original height of the interlaced image. Interpolation and other known methods may be used to stretch the image. It should be appreciated that, depending on user preferences, the image may be stretched different amounts, or even shrunk.

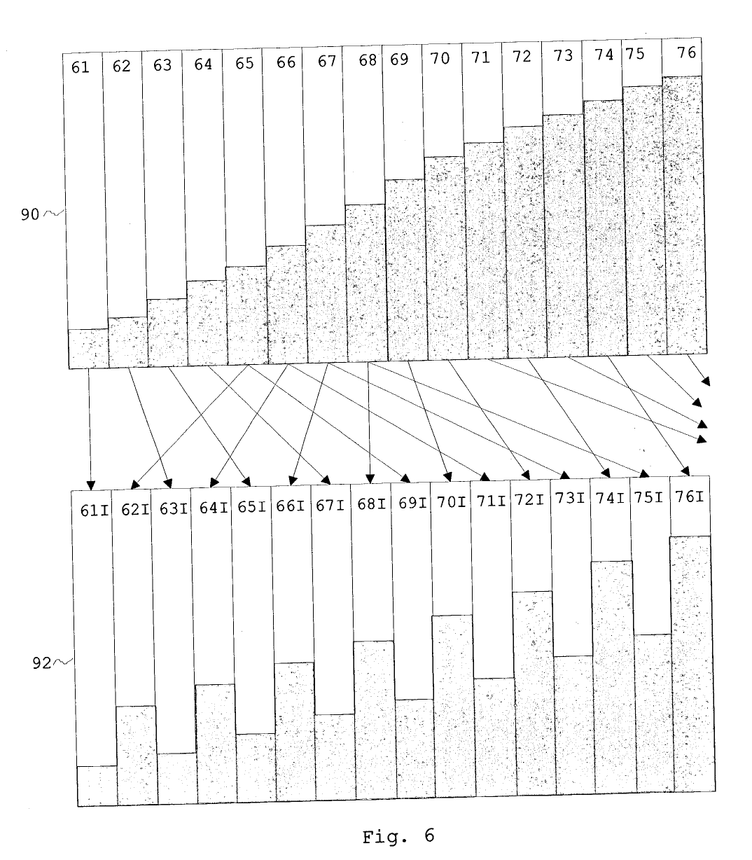

In a second embodiment, a digitized image is interlaced with itself to provide an interlaced image, and a lens, preferably a lenticular sheet 30, is positioned atop the interlaced image to provide a modified image. A digitized image 90 of a geometric pattern comprising a plurality of image columns (61-76) is shown interlaced with itself in FIG. 6. In one embodiment, a first set of columns that comprises substantially all of the plurality of image columns (61-76) is interlaced with a second set of columns to provide the interlaced image 92. The second set of columns (65-76) is derived directly from the digitized image and comprises columns of the digitized image that are horizontally offset from the first set of columns. The second set of columns (65-76) is derived directly from the digitized image because it is a subset of the plurality of columns that comprises the digitize image. To create an offset of four columns, columns of the first set of columns (61-76) are positioned in every alternate column position of the interlaced image 92. Thus, the first (61), second (62), and third (63) columns of the digitized image are positioned in the first (61I), third (63I), and fifth (65I) column positions, respectively, of the interlaced image 92, and this is repeated for the remaining columns of the first set of columns. The second set of columns (65-76) are positioned in every alternate column position of the interlaced image 92, starting with the second column position (62I). Thus, the fifth (65), sixth (66), and seventh (67) columns of the digitized image are positioned in the second (62I), fourth (64I), and sixth (66I) column positions of the interlaced image 92, and this is repeated for the remaining columns of the second set of columns. In essence, the second set of columns, which includes the fifth (65), sixth (66), and seventh (67) columns of the digitized image, are analogous to an image that is horizontally offset from the digitized image by four columns, and the second (72I), fourth (74I), and sixth (76I) column positions of the interlaced image are where the first three columns of a horizontally offset image would have been positioned, had a horizontally offset image been used.

The second embodiment desirably provides substantially the same interlaced image as would be provided had the digitized image been interlaced with an offset image; but, in the second embodiment, an offset image is not necessary to create the interlaced image. As a result, processing power is conserved when a processing unit 14 is used to interlace the digitized image. Those skilled in the art will appreciate that the alternate embodiment can be varied based on several factors discussed above, including varying the width of the digitized image based on the desired width of the modified image, and varying the column positions of the interlaced image that the image columns and the horizontally offset columns will be positioned in based on the output resolution of the output device, the lenticular density of the lenticular sheet 30, and the number of times that the digitized image will be interlaced with itself.

In a third embodiment, as shown in FIG. 2, an electronic system 12 is used to carry out methods of the invention. The electronic system 12 includes a processing unit 14, an input device 16, an output device 18, and a storage device 20. The image 10 is input into the electronic system 12 with the input device 16, which can be, for example, a scanner or a digital camera lens and sensor. The processing unit 14 is configured to divide the image into a plurality of columns and to interlace a first and second set of columns to provide an interlaced image. The first set of columns comprises substantially all of the plurality of image columns, and the second set of columns comprises columns horizontally offset from the first set of columns. The second set of columns is derived from the image. The processing unit can be, for example, a programmable processor that is used in a computer system, or an integrated circuit that is used in a digital camera. In other embodiments, the electronic systems include an output device 18, such as a monitor or a printer, and a storage device 20. The image 10 may then be printed onto a form of media by the output device 18 and stored in the storage device 20. Those skilled in the art will appreciate that the invention covers several different electronic systems 12. Examples of electronic systems of the invention include, without limitation: (1) a computer system having a processing unit, such as a programmable processor, an input device, such as a scanner, an output device, such as a printer, and a storage device; and, (2) a digital camera having a processing unit, such as an integrated circuit, an input device, such as a lens, and a storage device.

Having thus described a preferred embodiment of a method and apparatus for modifying 2D images, it should be apparent to those skilled in the art that certain advantages of the within system have been achieved. It should also be appreciated that various modifications, adaptations, and alternative embodiments thereof may be made within the scope and spirit of the present invention. For example, scanned two-dimensional images have been illustrated, but it should be apparent that the inventive concepts described above would be equally applicable to images already provided in digital format. The invention is further defined by the following claims.

What is claimed is:

1. A method of creating an interlaced image, comprising:
providing a two-dimensional image that includes a plurality of image columns; and,
interlacing substantially all of the plurality of image columns with horizontally offset columns to provide an interlaced image, the horizontally offset columns comprising columns horizontally offset from the plurality of image columns, the horizontally offset columns being derived from the two-dimensional image.

2. The method of claim 1, further comprising horizontally offsetting substantially all of the plurality of image columns of the two-dimensional image to provide an offset image having horizontally offset columns, wherein the interlacing step further comprises interlacing the horizontally offset columns of the offset image with the plurality of image columns to prepare the interlaced image.

3. The method of claim 1, further comprising saving the two-dimensional image with the plurality of image columns in a storage device, copying the two-dimensional image to provide a copied image having a plurality of copied image columns, and horizontally offsetting substantially all of the plurality of copied image columns to provide an offset image having horizontally offset columns, wherein the interlacing step further comprises interlacing the horizontally offset columns of the offset image with the plurality of image columns to prepare the interlaced image.

4. The method of claim 1, wherein the interlacing step further comprises interlacing substantially all of the plurality of image columns with horizontally offset columns, each of the horizontally offset columns being horizontally offset from the plurality of image columns an equal amount.

5. The method of claim 1, wherein the interlacing step further comprises interlacing the plurality of image columns with the horizontally offset columns with a processing unit.

6. The method of claim 1, wherein the providing step further comprises dividing the two-dimensional image into a plurality of columns with a processing unit.

7. The method of claim 1, wherein the providing step further comprises providing the two-dimensional image so that the two-dimensional image includes a predetermined number of image columns, where the predetermined number of image columns is based in part on a desired width of the interlaced image.

8. The method of claim 1, wherein the interlacing step further comprises interlacing the plurality of image columns with the horizontally offset columns, the horizontally offset columns being horizontally offset a predetermined amount that is based in part on a total number of image columns that comprises the two-dimensional image.

9. The method of claim 1, further comprising positioning a lens on the interlaced image to enable a modified image to be viewed.

10. The method of claim 9, further comprising positioning a lenticular sheet having a predetermined number of lenticules on the interlaced image.

11. The method of claim 10, further comprising outputting the interlaced image at a predetermined resolution.

12. The method of claim 11, wherein the interlacing step further comprises making a predetermined number of copies of the plurality of image columns and the horizontally offset columns, where the predetermined number of copies is based in part on the predetermined resolution and based in part on the predetermined number of lenticules.

13. The method of claim 1, further comprising outputting the interlaced image on a lens so that the lens is on the interlaced image.

14. The method of claim 1, further comprising vertically adjusting a height of the interlaced image.

15. The method of claim 1, wherein the interlacing step further comprises interlacing the plurality of image columns with the horizontally offset columns, the horizontally offset columns being derived directly from the two-dimensional image.

16. An interlaced image produced by the process of claim 1.

17. An apparatus for viewing an interlaced image, comprising:
a form of media having a plurality of image columns and horizontally offset columns formed thereon, wherein the horizontally offset columns are derived from the plurality of image columns and substantially all of the horizontally offset columns are horizontally offset with respect to the plurality of image columns, the plurality of image columns and the horizontally offset columns being interlaced with one another.

18. The apparatus of claim 17, further comprising a lenticular sheet having a plurality of lenticules, wherein the lenticular sheet is positioned atop the form of media so that each lenticule overlays a predetermined number of image columns and horizontally offset columns.

19. The apparatus of claim 17, wherein the form of media comprises a sheet of paper.

20. The apparatus of claim 17, wherein the form of media comprises a lenticular sheet having a plurality of lenticules, the plurality of image columns and the horizontally offset columns being interlaced with one another so that each lenticule overlays a predetermined number of columns of the plurality of image columns and of the horizontally offset columns.

21. An electronic system, comprising:
an input device configured to receive an image; and,
a processing unit in electrical communication with the input device, the processing unit being configured to divide the image into a plurality of image columns and to interlace substantially all of the plurality of image columns with the horizontally offset columns to provide an interlaced image, the horizontally offset columns comprising columns horizontally offset from the plurality of image columns, wherein the horizontally offset columns are derived from the image.

22. The electronic system of claim 21, wherein the input device comprises a camera lens and a light sensor.

23. The electronic system of claim 21, further comprising a storage device in electrical communication with the processing unit, the storage device configured to store the interlaced image.

24. The electronic system of claim 21, further comprising an output device in electrical communication with the processing unit.

25. The electronic system of claim 21, further comprising a printer configured to print the interlaced image onto a form of media.

26. The electronic system of claim 21, wherein the input device comprises a scanner.

27. The electronic system of claim 21, wherein the processing unit comprises an integrated circuit.

28. The electronic system of claim 21, wherein the processing unit comprises a programmable processor.

29. The electronic system of claim 21, wherein the interlacer is configured to interlace the plurality of image columns with the horizontally offset columns, the horizontally offset columns being derived directly from the image.

30. The electronic system of claim 21, wherein the processing unit comprises an offsetter, the offsetter being configured to offset substantially all of the plurality of image columns to provide an offset image having horizontally offset columns, wherein the processing unit is configured to interlace the horizontally offset columns of the offset image with the plurality of image columns to prepare the interlaced image.
